(19) United States
(12) Patent Application Publication
(10) Pub. No.: US 2010/0285679 A1
(43) Pub. Date: Nov. 11, 2010

(54) SPRING BOOT

(76) Inventors: Ryan A. Miller, Columbus, OH (US); Eric M. Heitkamp, Columbus, OH (US)

Correspondence Address: Emerson, Thomson & Bennett, LLC, 1914 Akron-Peninsula Road, Akron, OH, 44313, US

(21) Appl. No.: 12/435,432

(22) Filed: May 5, 2009

(51) Int. Cl. H01R 13/44

(52) U.S. Cl. 439/139; 439/149; 439/34

(57) ABSTRACT

An electrical terminal connector assembly includes a protective cover for substantially enclosing an electrical terminal on a vehicle component when the assembly is in a connected or disconnected condition.

### I. BACKGROUND OF THE INVENTION

A. Field of Invention

This invention relates generally to electrical wiring in vehicles and more particularly to a protective covering.

B. Description of the Related Art

It is well known in the art to provide a protective cover or boot to cover a connection point between an electrical wire and a vehicle component. The protective cover prevents contact with the connection point that could result in a short circuit. The boot is typically made out of an electric current insulating (i.e., non-conductive) material such as rubber.

A rubber boot 2 of the prior art is shown in FIGS. 1a and 1b. The rubber boot 2 covers an electrical terminal 6 on a vehicle component 4 when an electrical wire 5 is connected to the electrical terminal 6, as shown in FIG. 1a. However, if the terminal 6 is fractured, such as may occur for example in a vehicle accident, the rubber boot 2 no longer covers the exposed end 8 of the terminal 6, as shown in FIG. 1b. This exposed end 8 could contact another object and create an electric short circuit. This is undesirable.

While known protective covers generally work well for their intended purpose, there are limitations. The standard rubber boot effectively covers the connection point unless the connection between the electrical wire and the vehicle component is broken. In this case, the end of the electrical wire, or a broken portion of a vehicle component connected to the wire, is exposed and could make contact with an object or person and create a short circuit.

Therefore, what is needed is a protective cover for effectively covering the end of an electrical wire to protect the wire should the connection point between the wire and a vehicle component become broken, such a may occur in a vehicular accident.

### II. SUMMARY

According to one embodiment of this invention, an electrical terminal connector assembly, for a vehicle having a first component adapted for electrical connection to a second component, includes: (1) an electrical wire adapted for connection to an electrical terminal of the second component at an end of the wire, and (2) a protective cover defining an interior and having a flexible portion movable between expanded and compressed states. The protective cover provides three conditions for the connector assembly including: (1) a pre-connected condition prior to an electrical connection between the wire and the terminal of the second component in which the cover is expanded and the end of the wire located within the interior of the cover, (2) a connected condition in which the protective cover is compressed and the end of the wire is secured to the terminal of the second component within the interior of the cover, and (3) a disconnected condition in which the cover is expanded and the terminal of the second component is fractured, the end of the electrical wire and a fractured portion of the terminal located within the interior of the cover.

According to another embodiment of this invention, the flexible portion includes a plurality of corrugations and a first end with a first perimeter and a second end with a second perimeter. The second end of the flexible portion extends beyond the fractured portion of the electrical terminal of the second component in the disconnected condition. The second perimeter may be larger than the first perimeter.

One advantage of this invention is that an electrical wire is protected from causing a short circuit when the wire is in a connected condition.

Another advantage of this invention is that an electrical wire is protected from causing a short circuit when the wire is in disconnected or in a broken condition.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1a is a side view of a protective cover of the prior art.

FIG. 1b is a side view of the protective cover of FIG. 1a showing the cover after an electrical connection between a wire and a vehicle component has been broken.

FIG. 2 is a perspective view of a vehicle.

FIG. 3 is a front perspective view of a vehicle showing the engine compartment.

FIG. 4 is a schematic view of an electrical connection to a vehicle starter.

FIG. 5a is a side view of a protective cover according to an exemplary embodiment of this invention.

FIG. 5b is a side view of the protective cover of FIG. 5a showing the cover after an electrical connection between a wire and a vehicle component has been broken.

FIG. 5c is side view of a protective cover according to another exemplary embodiment of this invention.

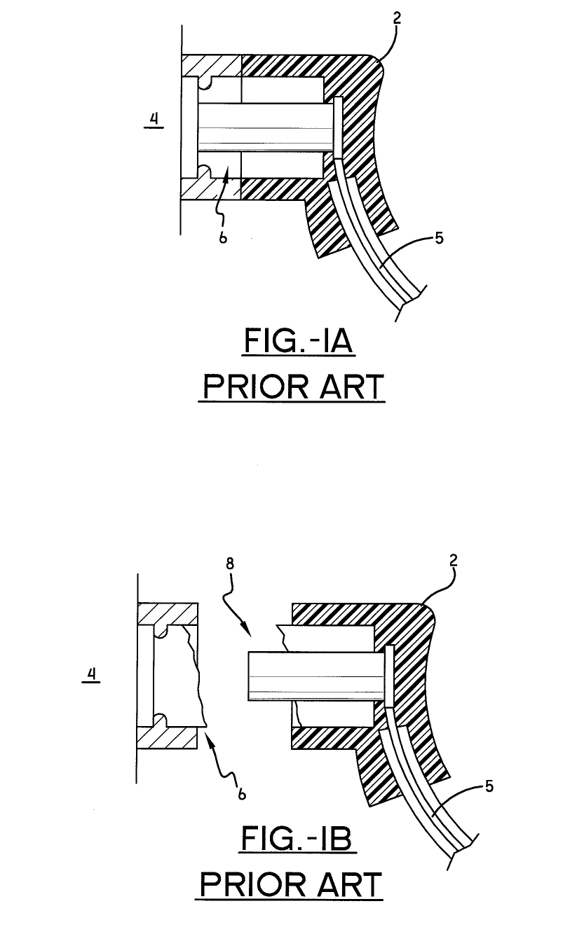

### IV. DETAILED DESCRIPTION

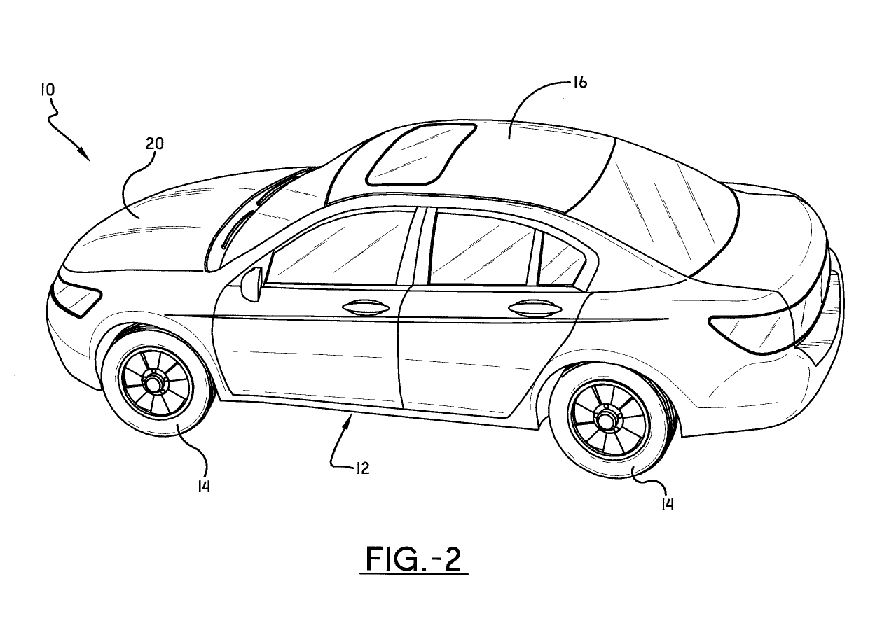

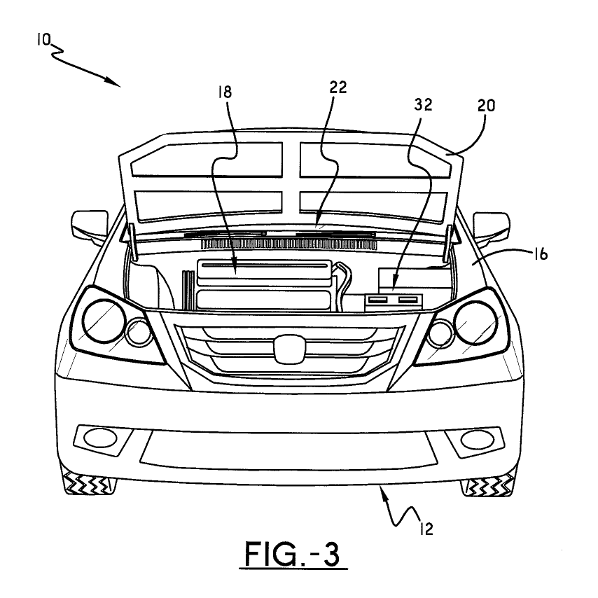

Referring to the drawings wherein the showings are for purposes of illustrating embodiments of the invention only and not for purposes of limiting the same, and wherein like reference numerals are understood to refer to like components, FIGS. 2 and 3 show a vehicle 10 that may be equipped with a electrical terminal connector assembly 100 according to one embodiment of this invention. While the vehicle 10 shown in FIGS. 2 and 3 is a sedan, it is to be understood that the electrical terminal connector assembly 100 of this invention will work with any vehicle including, for some non-limiting examples, cars, vans, trucks, sports utility vehicle (SUV), airplanes, and boats. The depicted vehicle 10 includes a frame 12, one or more ground engaging wheels 14 operatively mounted to the frame 12, a body 16 mounted to the frame 12, and an engine 18 mounted to the frame 12 for use in providing locomotion for the vehicle 10. The vehicle 10 includes a hood 20 for covering and allowing access to an engine compartment 22. The engine compartment 22 includes a battery 32 for providing power to an electrical system 30 in the vehicle 10.

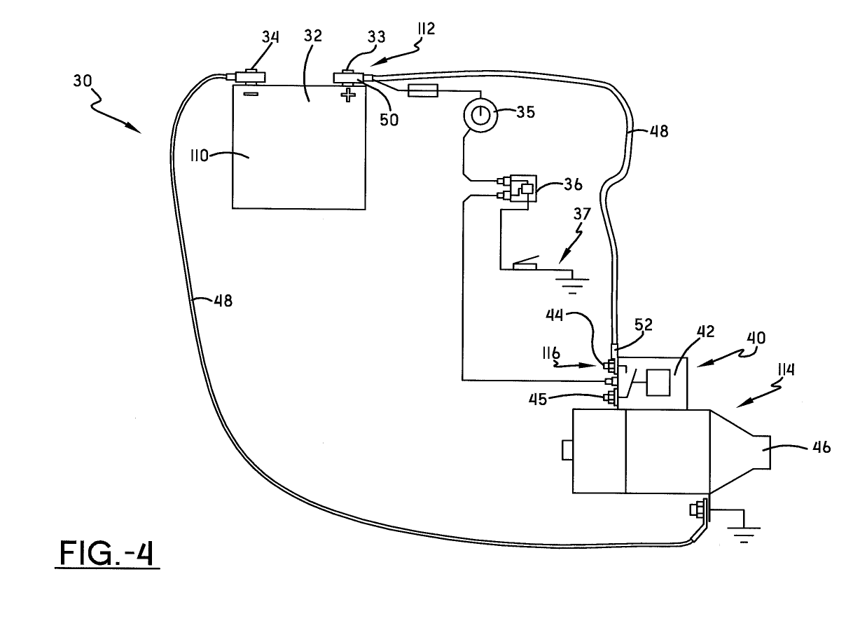

With reference now to FIG. 4, the depicted electrical system 30 includes the battery 32, the starter 40, an ignition switch 35, a starter relay 36, and a neutral safety switch 37. The starter 40 includes a starter solenoid 42 and a starter motor 46. The starter motor 46 can be an electric motor. When the neutral safety switch 37 is closed, the starter relay 36 allows the ignition switch 35 to actuate the starter solenoid 42. When the neutral safety switch 37 is open, the starter relay 36 is open and the ignition switch 35 cannot actuate the starter solenoid 42. For a vehicle with an automatic transmission, the neutral safety switch 37 is closed when the transmission shifter is in the “Park” or “Neutral” positions. For a vehicle with a manual transmission, the neutral safety switch 37 is closed when the clutch pedal is depressed. When the ignition switch 35 actuates the starter solenoid 42, the starter solenoid 42 connects the battery 32 to the starter motor 46. The battery 32 includes a positive terminal 33 and a negative terminal 34. The starter solenoid 42 may have two terminals 44, 45. A wire 48 connects the positive terminal 33 of the battery 32 to the terminal 44 of the solenoid 42. The wire 48 may be a battery cable ranging in size from 6 gauge up to 4/0 gauge. The wire 48 from the battery 32 may be manufactured to S.A.E. specification J-1127. A second wire 48 connects the terminal 45 of the starter solenoid 42 to the starter motor 46. A third wire 48 connects the negative terminal 34 of the battery 32 to the engine 18, the frame 12, or the starter 40.

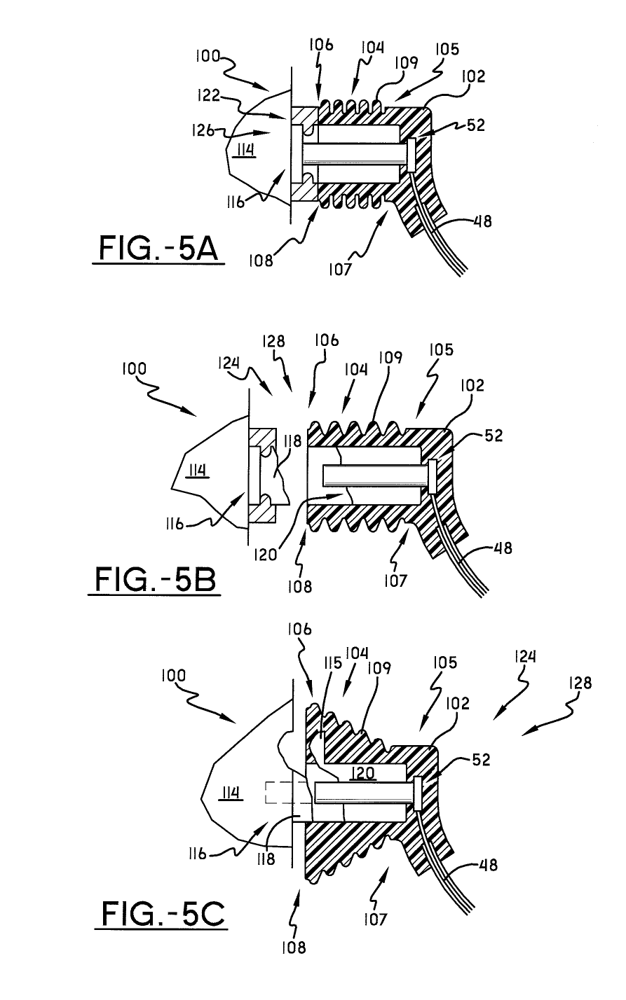

With reference now to FIGS. 4 and 5a-5c, the depicted electrical terminal connector assembly 100 includes a protective cover 102. The protective cover 102 may be formed of any material chosen by one with ordinary skill in the art. In one embodiment, the protective cover 102 is formed from a resilient or elastic material, such as rubber. The protective cover 102 includes a flexible portion 104, which is capable of returning to its original length and shape after being stretched, deformed, compressed, or expanded. FIG. 5a shows the protective cover 102 in a compressed condition 122. FIGS. 5b and 5c, respectively, show the protective cover 102 of FIG. 5a and an alternative embodiment of the protective cover 102 in an extended or expanded condition 124. In one embodiment, the original length and shape of the flexible portion 104 is the expanded condition 124. The depicted flexible portion 104 includes a plurality of corrugations 109 for providing a spring effect to expand or extend the flexible portion 104 and bias the flexible portion towards the expanded condition 124. Alternatively, the protective cover 102 may include a spring mechanism to bias the flexible portion 104. The spring mechanism may be, but is not limited to, a metal or plastic spring, a coil spring, or any other resilient or elastic material chosen by one with ordinary skill in the art. The flexible portion 104 may have a first end 105 with a first perimeter 107 and a second end 106 with a second perimeter 108. The first perimeter 107 may be substantially the same as the second perimeter 108, a shown in FIGS. 5a and 5b. In one embodiment, the second perimeter 108 is larger than the first perimeter 107, as shown in FIG. 5c, and may be referred to as a wide mouth boot. Referring to FIG. 4, one end 50 of the wire 48 is connected to an electrical terminal 112 on a first vehicle component 110 and the second end 52 of the wire 48 is connected to an electrical terminal 116 on a second vehicle component 114. In the depicted embodiment, end 50 of the wire 48 is connected to the positive terminal 33 of the battery 32 and the end 52 of the wire 48 is connected to the terminal 44 of the solenoid 42. The protective cover 102 covers the second end 52 of the wire 48 and the terminal 44 of the solenoid 42 from any unintentional or unwanted contact to the ground and the resulting short circuit.

With reference now to FIGS. 2-4 and 5a-5c, the operation of the electrical terminal connector assembly 100 will now be described. The electrical terminal connector assembly 100 provides three conditions in operation. The conditions include a pre-connected condition, in which the protective cover 102 is expanded and the second end 52 of the electrical wire 48 is located within an interior of the cover 102. The conditions include a connected condition 126, in which the protective cover 102 is compressed and the second end 52 of the electrical wire 48 is secured to a second electrical terminal 116 on the second vehicle component 114, as shown in FIG. 5a. The conditions include a disconnected condition 128, in which the second terminal 116 is fractured into a first fractured portion 118 and a second fractured portion 120, as shown in FIGS. 5b and 5c. In the depicted embodiment, the first fractured portion 118 remains attached to the second vehicle component 114 and the second fractured portion 120 remains attached to the second end 52 of the electrical wire 48. As shown, the protective cover 102 is expanded and the second fractured portion 120 is located within the interior of the cover 102 along with the second end 52 of the wire 48. The protective cover 102 in FIG. 5c can be used to cover a larger second fractured portion 120 that may include a portion 115 of the second vehicle component 114.

Numerous embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

1. An electrical terminal connector assembly for a vehicle having a first component adapted for electrical connection to a second component, the electrical terminal connector assembly comprising:
an electrical wire operatively connected to an electrical source and adapted for connection to an electrical terminal of the second component at an end of the wire; and
a protective cover defining an interior and having a flexible portion movable between expanded and compressed states, the protective cover providing three conditions for the connector assembly including:
a pre-connected condition prior to an electrical connection between the wire and the terminal of the second component in which the cover is expanded and the end of the wire located within the interior of the cover,
a connected condition in which the protective cover is compressed and the end of the wire is secured to the terminal of the second component within the interior of the cover, and
a disconnected condition in which the cover is expanded and the terminal of the second component is fractured, the end of the electrical wire and a fractured portion of the terminal are located within the interior of the cover to prevent a short circuit of the electrical wire.

2. (canceled)

3. (canceled)

4. The electrical terminal connector assembly of claim 21, wherein the flexible portion is biased towards the expanded state.

5. The electrical terminal connector assembly of claim 21, wherein the protective cover is made of rubber.

6. The electrical terminal connector assembly of claim 21, wherein the first vehicle component is a battery.

7. The electrical terminal connector assembly of claim 6, wherein the second vehicle component is a starter.

8. The electrical terminal connector assembly of claim 6, wherein the wire is a non-fused battery cable.

9. A vehicle comprising:
a first vehicle component having an electrical terminal;
a second vehicle component having an electrical terminal;
a wire operatively connected to an electrical source and having a first end electrically connected to the terminal of the first vehicle component and a second end electrically connected to the terminal of the second vehicle component;
a protective cover having an interior and a flexible portion movable between expanded and compressed states and the protective cover providing three conditions including:
a pre-connected condition, in which the protective cover is expanded and the second end of the electrical wire is located within the interior of the cover;
a connected condition, in which the cover is compressed and the second end of the electrical wire is secured to the terminal of the second vehicle component within the interior of the cover; and,
a disconnected condition in which the cover is expanded and the terminal of the second component is fractured, the second end of the electrical wire and a fractured portion of the terminal are located within the interior of the cover to prevent a short circuit of the electrical wire.

10. (canceled)

11. (canceled)

12. The vehicle of claim 23, wherein the flexible portion is biased towards the expanded state.

13. The vehicle of claim 23, wherein the protective cover is made of rubber.

14. The vehicle of claim 23, wherein the first vehicle component is a battery.

15. The vehicle of claim 14, wherein the second vehicle component is a starter.

16. The vehicle of claim 14, wherein the wire is a non-fused battery cable.

17. A method comprising the steps of:
providing a first vehicle component having a first electrical terminal;
providing a second vehicle component having a second electrical terminal;
providing a wire for electrically connecting the vehicle components and operatively connecting the wire to an electrical source;
providing a protective cover having an interior and a flexible portion movable between expanded and compressed conditions;
connecting a first end of the wire to the first electrical terminal of the first vehicle component;
connecting a second end of the wire to the second electrical terminal of the second vehicle component, wherein the protective cover is compressed and the second end of the electrical wire is secured to the second terminal within the interior of the cover;
expanding the protective cover to position the second end of the electrical wire and a fractured portion of the second terminal within the interior of the protective cover to prevent a short circuit of the electrical wire when the second vehicle component fractures.

18. The method of claim 17, wherein the first vehicle component is a battery, the second vehicle component is a starter, and the wire is a non-fused battery cable.

19. The method of claim 17, wherein the flexible portion of the protective cover further comprises:
a plurality of corrugations;
a first end having a first perimeter, wherein the first end is substantially fixed with respect to the wire in both the expanded and compressed conditions; and
a second end having a second perimeter, wherein the second perimeter is substantially larger than the first perimeter, and wherein the second end extends beyond the fractured portion of the second terminal in the expanded condition.

20. The method of claim 17, wherein the step of expanding the protective cover further comprises expanding the protective cover to position a fractured portion of the second vehicle component, which is different from the fractured portion of the second terminal, within the interior of the protective cover when the second vehicle component fractures.

21. The electrical terminal connector assembly of claim 1, wherein the flexible portion of the protective cover further comprises:
a plurality of corrugations;
a first end having a first perimeter, wherein the first end is substantially fixed with respect to the wire in both the expanded and compressed conditions; and
a second end having a second perimeter, wherein the second perimeter is substantially larger than the first perimeter, and wherein the second end extends beyond the fractured portion of the second terminal in the expanded condition.

22. The electrical terminal connector assembly of claim 1, wherein the disconnected condition further comprises a fractured portion of the second component, which is different from the fractured portion of the terminal, located within the interior of the cover.

23. The vehicle of claim 9, wherein the flexible portion of the protective cover further comprises:
a plurality of corrugations;
a first end having a first perimeter, wherein the first end is substantially fixed with respect to the wire in both the expanded and compressed conditions; and
a second end having a second perimeter, wherein the second perimeter is substantially larger than the first perimeter, and wherein the second end extends beyond the fractured portion of the second terminal in the expanded condition.

24. The vehicle of claim 9, wherein the disconnected condition further comprises a fractured portion of the second component, which is different from the fractured portion of the terminal, located within the interior of the cover.
